(19) United States
(12) Patent Application Publication
(10) Pub. No.: US 2019/0103044 A1
(43) Pub. Date: Apr. 4, 2019

(54) LIGHT CONTROL FLAG FASTENING DEVICE

(71) Applicant: Paul Bates, Glasgow (GB)

(72) Inventor: Paul Bates, Glasgow (GB)

(21) Appl. No.: 16/083,172

(22) PCT Filed: Mar. 7, 2017
(86) PCT No.: PCT/GB2017/050604

§ 371 Date: Sep. 7, 2018

(30) Foreign Application Priority Data
Mar. 8, 2016 (GB) 1603995.0

(51) Int. Cl. G09F 17/00; G03B 15/06

(52) U.S. Cl. CPC G09F 17/00; G09F 2017/005; G09F 2017/0041; G03B 15/06

(57) ABSTRACT

A fastening device for a light control flag includes a batten including at least one flag fastener, where in use the flag fastener secures a portion of a light control flag to the batten. A support fastener is attached to the batten, where in use the support fastener affixes the batten to a support member of the light control flag. A light control flag including the light control flag fastening device, and a method of securing a portion of a light control flag, are also described.

### FIELD OF THE INVENTION

This invention relates to light control flags, and in particular devices for fastening light control flags.

### BACKGROUND OF THE INVENTION

Due to advances in the quality of digital recording, the film industry is increasingly relying on digital recording methods rather than analogue recording methods. To increase the contrast on a subject when digital recording is used, such as when the subject is outdoors, an effect known as negative fill can be employed. Negative fill adds contrast to the subject by removing the light shining on it, and can add more depth and dimension to an otherwise flat looking image. Generally, light control flags are used to remove light shining on the subject. Light control flags are also known in the industry as ‘floppy flags’, and generally comprise a large black opaque sheet which is suspended from a support frame. The large black opaque sheet usually comprises a black sheet of duvetyne fabric. The bottom of the flag is not attached to the frame so it has freedom to move. This can mean that when filming is taking place outside, the sheet can flutter in the wind. This in turn can affect the image by distorting the negative fill effect, and this can considerably slow down the filming process as many retakes need to be taken and the final image may end up being of less quality than desired.

It is an object of the present invention to provide a fastening device which prevents the bottom portion of the light control flag from moving.

### SUMMARY OF THE INVENTION

According to a first aspect of the present invention there is provided a light control flag fastening device comprising:
a batten including at least one flag fastener, the flag fastener in use securing a portion of a light control flag to the batten; and
a support fastener attached to the batten, the support fastener in use affixing the batten to a support member of the light control flag.

The flag fastener may be located on the surface of the batten.

The batten may further comprise an elongate slot, and the support fastener may further comprise a portion which is receivable in the slot such that the support fastener can slide longitudinally along the batten.

The support fastener may further comprise a recess portion and a belt, wherein the recess portion in use engages with an external surface of the support member, and wherein in use the belt encircles the external surface of the support member and secures the support fastener to the support member.

The support fastener may further comprise a projecting stud member, and the belt may comprise an attached end attached to the support fastener, a free end, and a plurality of apertures between the attached and free ends, and wherein the stud member is received in one of the apertures to secure the support fastener to the support member.

The free end of the belt may include a head portion which is capable of being received inside the elongate slot when the fastening device is not in use.

The flag fastener may be a hook and loop fastener.

The batten may have two sides where a first side is at least partially covered with a hook fastener material and a second side is at least partially covered with a loop fastener material.

The support fastener may comprise an elastomer.

According to a second aspect of the present invention there is provided a light control flag comprising the light control flag fastening device of any preceding claim.

According to a third aspect of the present invention there is provided a method of securing a portion of a light control flag comprising the steps of:
providing a batten which includes a support fastener attached thereto and at least one flag fastener;
securing the support fastener to a support member of the light control flag; and
securing a portion of the light control flag to the flag fastener along the batten.

The method may further comprise the steps of:
providing an elongate slot in the batten;
providing the support fastener with a portion which is receivable in the slot such that the support fastener can slide longitudinally along the batten; and
adjusting the longitudinal position of the support fastener on the batten.

The support fastener may comprise a recess portion and a belt, and the method may further comprise the steps of:

engaging the recess portion with an external surface of the support member; and
encircling the external surface of the support member with the belt so as to secure the support fastener to the support member.

The step of securing the support fastener to the support member comprises receiving a projecting stud member of the support fastener in one of a plurality of apertures located between attached and free ends of the belt.

### BRIEF DESCRIPTION OF THE DRAWINGS

Preferred embodiments of the present invention will now be described, by way of example only, with reference to the accompanying drawings, in which:

FIG. 1 shows a light control flag fastening device according to a first embodiment of the present invention;

FIG. 2 shows a support fastener of the device of FIG. 1;

FIG. 3 shows an end view of the support fastener of FIG. 2;

FIG. 4 shows a side view of an alternative support fastener which can be used with the device of FIG. 1;

FIG. 5 shows a top view of the support fastener of FIG. 4

FIG. 6 shows an unfastened light control flag;

FIG. 7 shows the light control flag of FIG. 6 fastened using the fastening device of FIG. 1; and

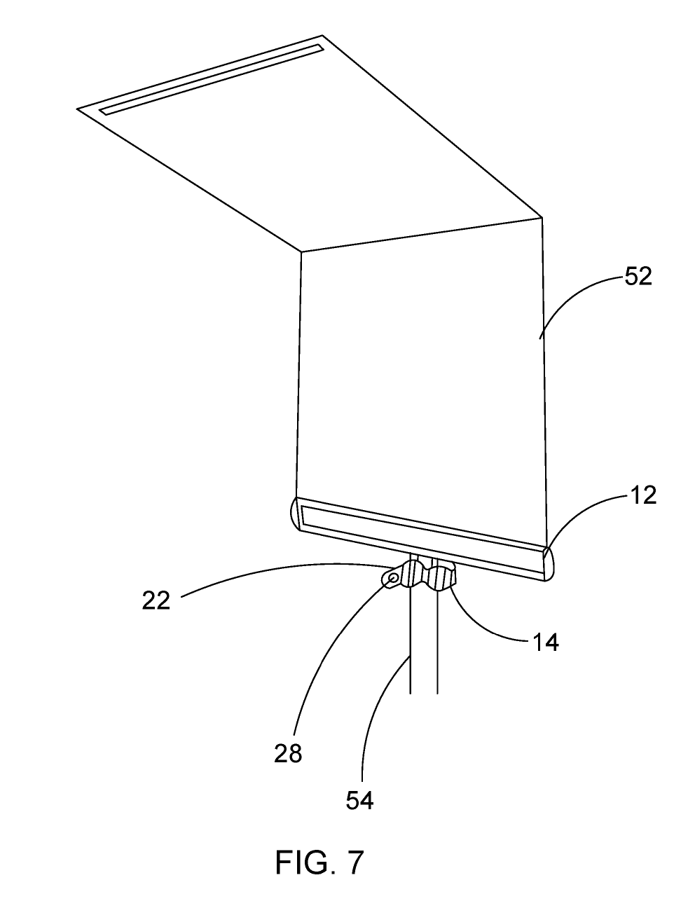

FIG. 8 shows a detail view of the fastening device and light control flag shown in FIG. 7.

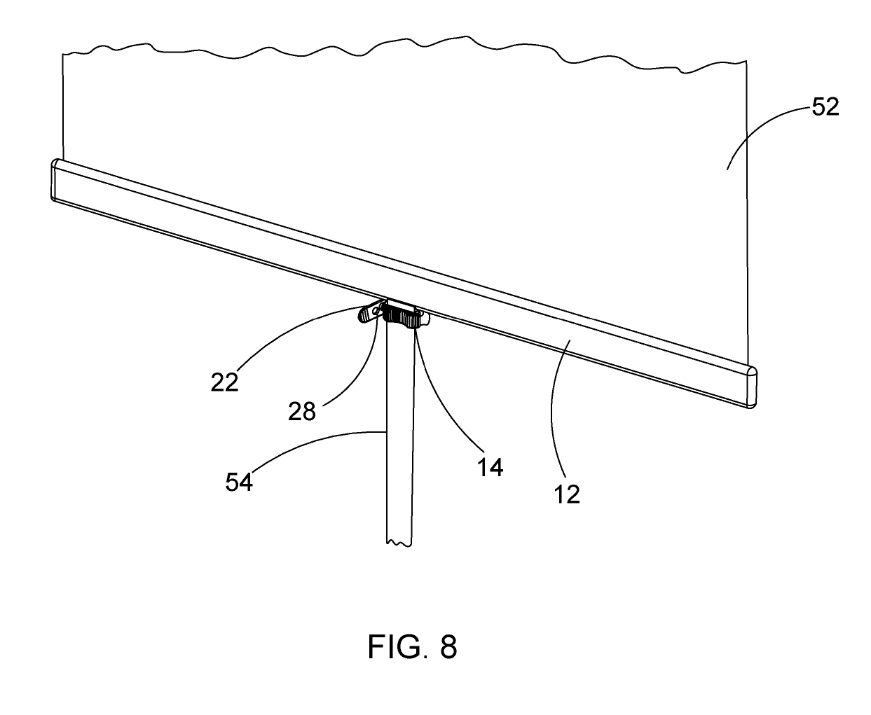

### DETAILED DESCRIPTION OF THE DRAWINGS

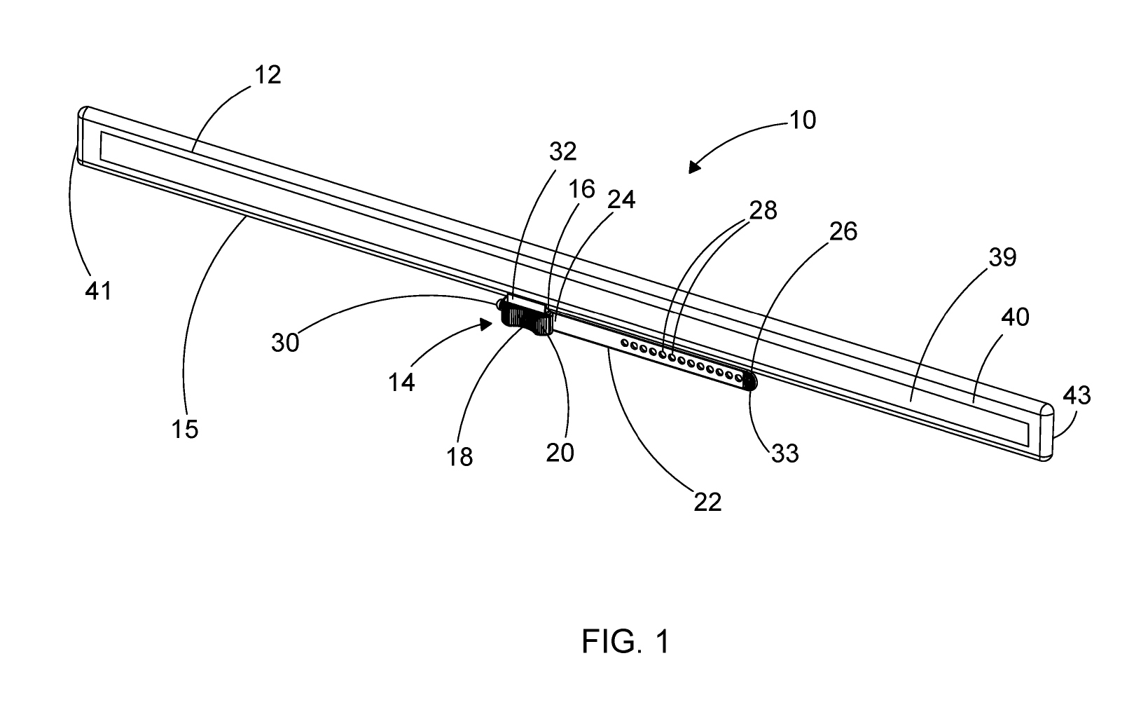

Referring to FIG. 1 there is shown a light control flag fastening device 10 according to a first embodiment of the present invention. The fastening device 10 comprises a batten 12 and a support fastener 14. The batten 12 is preferably formed from a plastics material by injection moulding, but can also be formed by 3D printing or another suitable method. In the first embodiment the batten 12 is formed from polyvinyl chloride, but other suitable types of plastic may be used such as, for example, acrylic plastic. The batten 12 may also be formed from a suitable rigid material such as wood or a metal, such as extruded aluminium, for example. In the first embodiment depicted, the batten 12 may be formed to be 1200 mm long, 70 mm high and 18mm thick. The above dimensions are selected so that the fastening device 10 may be used to secure a standard ‘4×4’ (1200 mm×1200 mm) light control flag used in the film industry. The batten 12 also includes a pair of removable end caps 41,43 which are preferably formed from a suitable elastomer such as ethylene propylene diene monomer (EPDM), for example. An elongate slot 15 extends longitudinally along the underside of the batten.

In a preferred embodiment of the invention, the batten 12 includes a flag fastener 39 located on the surface of the batten 12. The preferred flag fastener 39 is a hook and loop fastener. The batten 12 is substantially planar, and has first and second sides, with only the first side 40 visible in the figures. The hook and loop fastener is located on the surface of the first and second sides such that in use hook and loop fastener can fix onto a portion of a light control flag. In the preferred embodiment, the first side 40 is covered with hook fastener and the second side is covered with loop fastener, such that a user can fix one side of the batten 12 to a hook or loop fastener portion of the light control flag, depending on whether the hook or loop fastener portion comprises entirely hook fastener or entirely loop fastener.

The support fastener 14 has a body portion 16 that includes at least one recess portion 18 which is adapted to engage with the external surface of a support member which supports the light control flag. In the preferred embodiment the body portion 16 is formed of an elastomer such as natural or synthetic rubber, with EPDM being a preferred material. In the first embodiment of the invention depicted in FIG. 1, the recess portion 18 is curved such that it can easily engage with a surface of a cylindrical support member. A plurality of ribs 20 is located on an outer surface of the body portion 16. The ribs 20 extend across the recess portion 18, and enhance a user's grip of the support fastener 14.

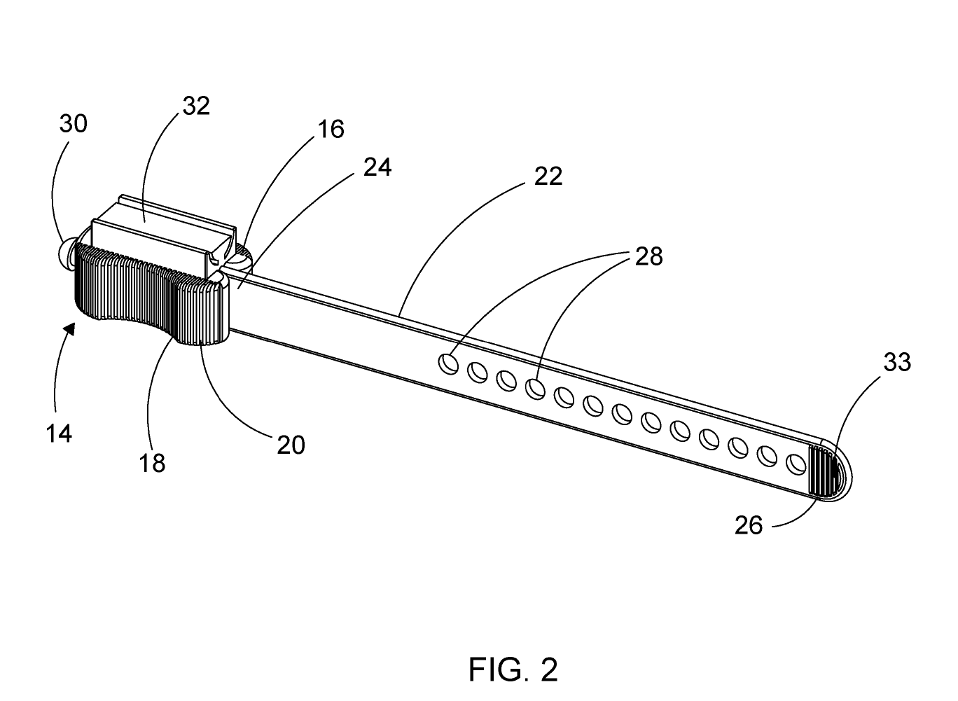

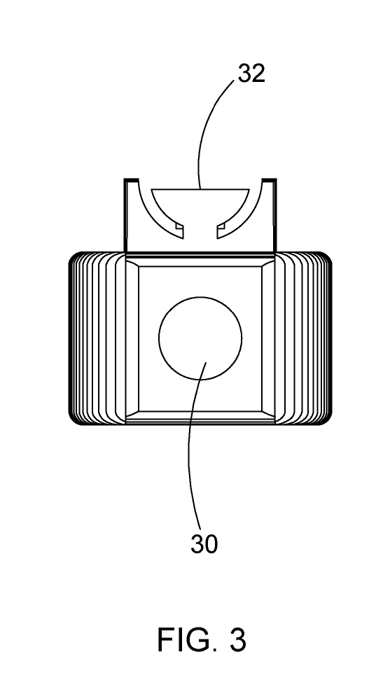

As best viewed in FIGS. 2 and 3 the support fastener 14 further includes a belt 22. The belt 22 is attached at a proximal end 24 to the body portion 16 and has a distal free end 26. A plurality of apertures 28 extend along the belt 22 between the proximal and distal ends 24,26. The belt 22 is adapted to encircle the support member when the recess portion 18 is engaged with an outer surface of the support member, so as to hold the support fastener to the support member. A projecting stud portion 30 is located on an opposite end of the body portion 16 from the belt 22, and in use is received in one of the apertures 28 to secure the belt 22 tightly around the support member. The body portion 16 also includes a slot engagement portion 32 which is received in the elongate slot 15 in the batten 12. The slot engagement portion 32 has a profile which is adapted to engage with a corresponding shaped profile of the elongate slot 15 so that the support fastener may slide back and forth in the slot to adjust its longitudinal position relative to the batten. The belt 22 also includes on its surface a plurality of belt ribs 33 at the free end 26. The belt ribs 33 provide increased friction for a user gripping the belt at the free end 26.

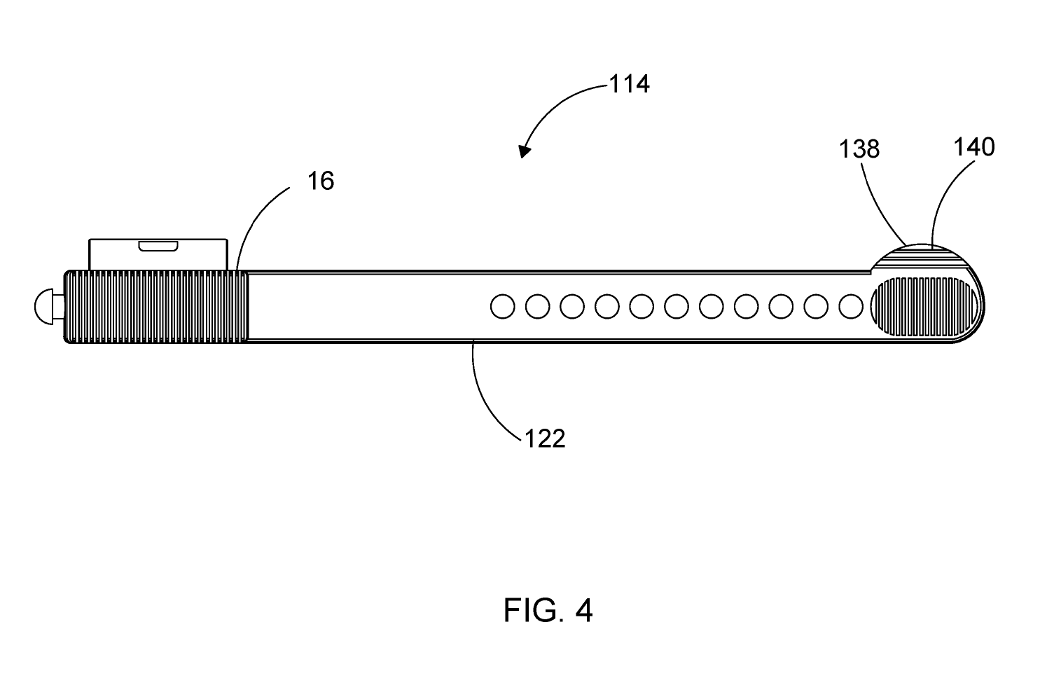

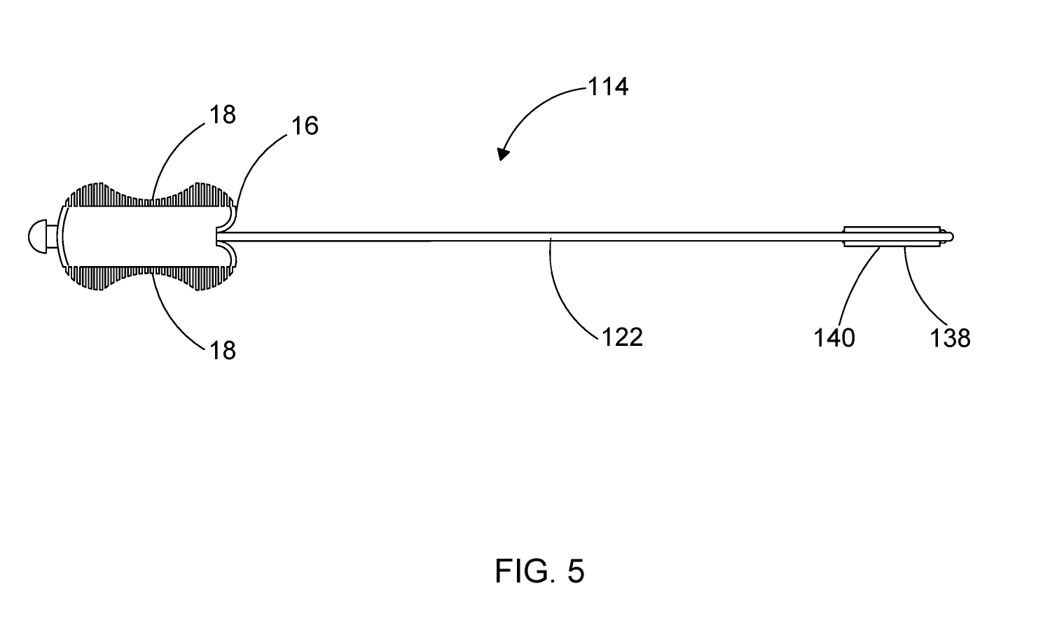

Referring now to FIGS. 4 and 5 there is shown an alternative support fastener 114 for use with the flag fastening device. The body portion 16 is as previously described. In the second embodiment, the belt 122 further comprises a head portion 138 located at the free end of the belt 122. The head portion 138 includes a head slot engagement portion 140 that has a profile which is adapted to engage with a corresponding shaped profile in the elongate slot 15. The head flange portion retains the head portion 138 inside the elongate slot 15 which extends longitudinally across the batten 12. The head key portion allows 140 the free end of the belt 126 to be received inside the elongate slot 15 when the fastener is not in use.

The body portion 16 of the support fastener is best shown in FIG. 5. The body portion 16 of FIG. 5 is common to both the first and second embodiments of the support fastener 114. As shown, the body portion 16 is symmetrical when viewed in plan, and has a recess portion 18 on each side of the belt 122.

### INDUSTRIAL APPLICABILITY

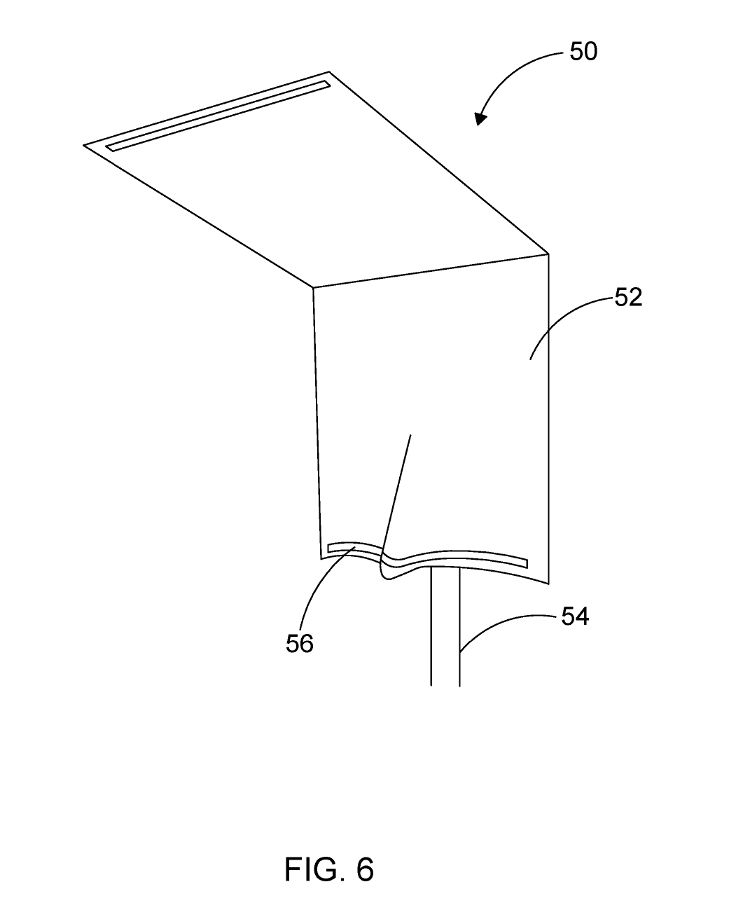

In FIG. 6 there is shown a light control flag 50 used for creating a negative fill effect when filming. The light control flag 50 comprises a fabric body 52 which is suspended from a frame (not shown). The frame is itself supported by a support member 54. The light control flag 50 includes a hook or loop fastener portion 56 on the bottom portion of the fabric body 52. The hook or loop faster portion 56 may be either a portion that comprises entirely hook fastener or a portion that comprises entirely loop fastener. A bottom portion of fabric body 52 is unsecured and free to move. This means that the bottom of the fabric body 52 can sway in the wind, and affect the negative fill effect.

In order to fasten the bottom portion of the fabric body 52 to prevent it from being able to move and sway in the wind, a user may use the light control flag fastening device 10 to fasten the bottom portion of the fabric body 52 to the support member 54.

To securely fasten the bottom portion of the fabric body 52 to the support member 54, the user simply selects a correct side from the first and second sides of the batten 12 that would be able to attach to the hook or loop fastener portion 56 on the bottom portion of the fabric body 52 depending on whether the hook or loop fastener portion 56 comprises hook fastener or loop fastener.

The user then fixes the correct side of the batten 12 to the hook or loop fastener portion 56. Once the batten 12 is fixed to the fabric body 52, the user secures the batten 12 to the support member 54 by engaging the recess portion 18 with the outer surface of the support member and then encircling the support member with the belt 22 and forcing the stud 30 through one of the apertures 28. The user selects one of the apertures 28 depending on the diameter of the support member 54, so as to obtain a secure grip of the belt 22 on the support member.

The user can vary the longitudinal position of the support fastener 14 along the batten by sliding the support fastener along the elongate slot 15 in the batten.

When the fastening device 10 is not in use the user can easily store the belt 22 by threading the head portion 138 inside the elongate slot. When the belt 22 is in the elongate slot, the user can tension the belt by sliding the head portion longitudinally away from the body portion 16.

Because the fastening device according to the present invention secures the bottom portion of the light control flag to the support member, the bottom portion cannot sway and affect the negative fill effect.

The flag fastener may not be located on the surface of the batten. The flag fastener may be separate from the batten. For example, mechanical fixtures such as clips or clamps may instead be used to attach the batten to the bottom portion of the flag.

The flag fastener located on the surface of the batten may not be a hook and loop fastener. The flag may have a plurality of female components of push button fasteners located on its surface and the batten may have a plurality of corresponding male components of push button fasteners located on its surface. In this embodiment of the invention, the male and female components mate when the batten is attached to the bottom portion of the flag.

The support fastener may not comprise the belt and stud arrangement described herein, but instead comprise a clamp which in use secures the batten to the support member. Furthermore, it is not essential to the invention that the support fastener includes a recess. The support fastener can still be attached to the support member without a recess.

For the avoidance of any doubt, the slot engagement portion and elongate slot in the batten are not essential features of the invention. It is preferable, but not essential to the invention that the longitudinal position of the support fastener is varied.

These and other modifications and improvements may be incorporated without departing from the scope of the claimed invention.

1. A light control flag fastening device comprising:
a batten including at least one flag fastener, the flag fastener for securing a portion of a light control flag to the batten; and
a support fastener attached to the batten, the support fastener for affixing the batten to a support member of the light control flag.

2. The fastening device according to claim 1, wherein the batten comprises an elongate slot, and the support fastener comprises a portion which is receivable in the slot such that the support fastener can slide longitudinally along the batten.

3. The fastening device according to claim 2, wherein the support fastener comprises a recess portion and a belt, wherein the recess portion is engageable with an external surface of the support member, and wherein the belt is configured to encircle the external surface of the support member to secure the support fastener to the support member.

4. The fastening device of claim 3, wherein the support fastener further comprises a projecting stud member, and the belt comprises an attached end attached to the support fastener, a free end, and a plurality of apertures located between the attached and free ends, and wherein the stud member is received in one of the apertures to secure the support fastener to the support member.

5. The fastening device of claim 4, wherein the free end of the belt includes a head portion which is configured to be received inside the elongate slot when the fastening device is not in use.

6. The fastening device according to claim 1, wherein the flag fastener is a hook and loop fastener.

7. The fastening device according to claim 6, wherein the batten has two sides, where a first side is at least partially covered with a hook fastener material and a second side is at least partially covered with a loop fastener material.

8. The fastening device according to claim 1, wherein the support fastener comprises an elastomer.

9. A light control flag comprising the light control flag fastening device of claim 1.

10. A method of securing a portion of a light control flag comprising:
providing a batten which includes a support fastener attached thereto and at least one flag fastener;
securing the support fastener to a support member of the light control flag; and
securing a portion of the light control flag to the flag fastener.

11. The method of claim 10, further comprising:
providing an elongate slot in the batten;
providing the support fastener with a portion which is receivable in the slot such that the support fastener can slide longitudinally along the batten; and
adjusting the longitudinal position of the support fastener on the batten.

12. The method of claim 10, wherein the support fastener comprises a recess portion and a belt, the method further comprising:
engaging the recess portion with an external surface of the support member; and
encircling the external surface of the support member with the belt to secure the support fastener to the support member.

13. The method of claim 12, wherein the step of securing the support fastener to the support member comprises receiving a projecting stud member of the support fastener in one of a plurality of apertures located between attached and free ends of the belt.
